(19) United States
(12) Patent Application Publication
(10) Pub. No.: US 2025/0033363 A1
(43) Pub. Date: Jan. 30, 2025

(54) LIQUID EJECTION APPARATUS

(71) Applicant: CANON KABUSHIKI KAISHA, Tokyo (JP)

(72) Inventors: TAKAYA SATO, Tokyo (JP); RAN KUDO, Tokyo (JP); MAIKO SHIINA, Tokyo (JP)

(21) Appl. No.: 18/783,093

(22) Filed: Jul. 24, 2024

(30) Foreign Application Priority Data
Jul. 25, 2023 (JP) 2023-121142

(51) Int. Cl. B41J 2/175; B41J 2/18; B41J 29/58

(52) U.S. Cl. CPC B41J 2/1752; B41J 2/17546; B41J 2/17566; B41J 2/18; B41J 29/58

(57) ABSTRACT

A liquid ejection apparatus includes a holding unit configured to hold a tray on which a container configured to contain liquid to be supplied to an ejection head is detachably mounted, a first restriction unit configured to be movable to a restriction position where the first restriction unit restricts pulling the tray out of the holding unit and to a non-restriction position where the first restriction unit does not restrict pulling the tray out of the holding unit, a connector configured to be in contact with a substrate of the container, and a second restriction unit configured to, in a case where the substrate is in contact with the connector and the first restriction unit is at the restriction position, restrict movement of the first restriction unit to the non-restriction position.

### BACKGROUND

### Field of the Disclosure

The present disclosure relates to a liquid ejection apparatus.

### Description of the Related Art

There are some ink-jet recording apparatuses having a configuration in which an ink container formed as a flexible bag is placed on a tray to be mounted to the ink-jet recording apparatus. Additionally, it has been known that liquid used for recording, such as ink, is blended with a color material that produces the color, and the color material precipitates over time.

Japanese Patent Application Laid-Open No. 2014-188790 discloses a configuration that allows an ink container to be pulled out of an apparatus for a user to perform stirring in the ink container.

However, the configuration of Japanese Patent Application Laid-Open No. 2014-188790 has an issue that air enters the supply port of the ink container containing ink pulled out of the apparatus, causing the evaporation of moisture contained in the ink. This can lead to increased concentration and viscosity of the ink, affecting image quality.

### SUMMARY

According to an aspect of the present disclosure, a liquid ejection apparatus includes a holding unit configured to hold a tray on which a container configured to contain liquid to be supplied to an ejection head is detachably mounted, a first restriction unit configured to be movable to a restriction position where the first restriction unit restricts pulling the tray out of the holding unit and to a non-restriction position where the first restriction unit does not restrict pulling the tray out of the holding unit, a connector configured to be in contact with a substrate of the container, and a second restriction unit configured to, in a case where the substrate is in contact with the connector and the first restriction unit is at the restriction position, restrict movement of the first restriction unit to the non-restriction position.

Further features of the present disclosure will become apparent from the following description of exemplary embodiments with reference to the attached drawings.

### BRIEF DESCRIPTION OF THE DRAWINGS

FIG. 1 illustrates a schematic configuration of a recording apparatus according to a first exemplary embodiment.

FIG. 2 is a perspective view illustrating a liquid supply apparatus according to the first exemplary embodiment.

FIGS. 3A and 3B are side views each illustrating a tray unlocked state and a tray locked state according to the first exemplary embodiment.

FIGS. 4A and 4B are top views each illustrating the tray unlocked state and the tray locked state according to the first exemplary embodiment.

FIG. 5 is a perspective view illustrating a tray and an ink container according to the first exemplary embodiment.

FIG. 6 is a perspective view illustrating a tray holding unit according to the first exemplary embodiment.

FIGS. 7A and 7B are side views each illustrating a stirring unit according to the first exemplary embodiment.

FIGS. 8A and 8B are schematic cross-sectional views each illustrating the stirring unit according to the first exemplary embodiment.

FIG. 9 is a control flowchart for exchanging the ink container according to the first exemplary embodiment.

FIG. 10 is a perspective view illustrating the liquid supply apparatus according to a second exemplary embodiment.

FIGS. 11A and 11B are side views each illustrating a lever unlocked state and a lever locked state according to the second exemplary embodiment.

FIGS. 12A and 12B are top views each illustrating the lever unlocked state and the lever locked state according to the second exemplary embodiment.

FIGS. 13A and 13B are side views each illustrating a stirring unit according to the second exemplary embodiment.

FIG. 14 is a control flowchart for exchanging the ink container according to the second exemplary embodiment.

### DESCRIPTION OF THE EMBODIMENTS

Exemplary embodiments of the present disclosure will now be described with reference to the drawings. However, the following exemplary embodiments do not limit the present disclosure, and not all combinations of features described in the exemplary embodiments are used as solving means of the present disclosure. Additionally, relative arrangement of constituent elements and the shape of each constituent element described in the exemplary embodiments are merely examples, and not intended to limit the scope of the present disclosure.

The term “recording” includes, in a broad sense, forming meaningful information, such as characters and graphic patterns, forming an image, a design, or a pattern on a recording medium regardless of whether the information is meaningful, and performing a process on a medium, irrespective of what is visible by human eyes. Additionally, a “recording medium” is assumed to be paper in the exemplary embodiments, but the recording medium can be a cloth, a plastic film, or other materials.

The term “ink” (which may be referred to as “liquid”) should be construed in a broad sense, similarly to the above-mentioned definition of “recording”. It is assumed that ink represents liquid that is applied to the recording medium and then can be used in forming an image, a design, and a pattern, in performing a process on the recording medium, or in perform ink processing (for example, coagulation or insolubilization of the color material in the ink applied to the recording medium).

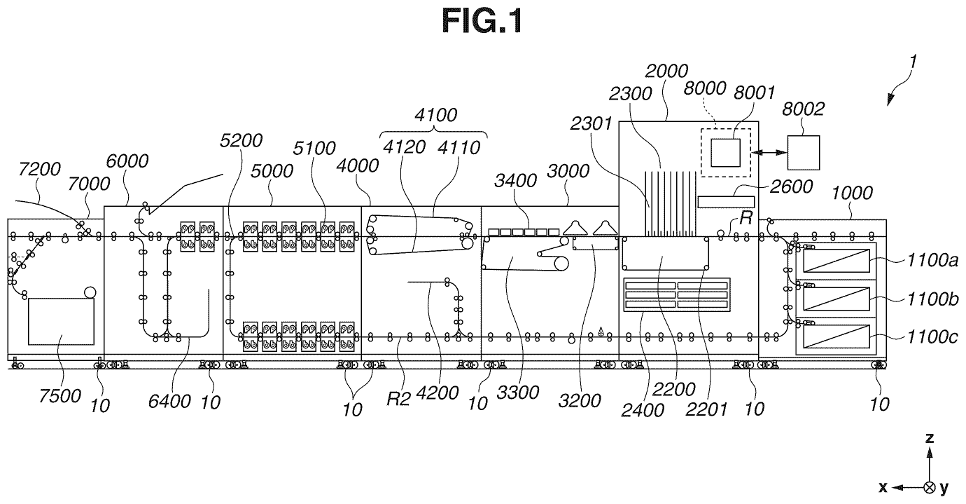

A first exemplary embodiment will be described. FIG. 1 illustrates an example of a schematic configuration of a recording apparatus 1 as a liquid ejection apparatus. The recording apparatus 1 is an ink-jet recording apparatus for cut sheet paper (cut paper) that forms an ink image on a sheet S, as a recording medium, using two kinds of liquid, reaction liquid and ink, to produce a recorded product.

In FIG. 1, the direction from the bottom to the top of the recording apparatus 1 is defined as the Z-direction, the conveyance direction of the sheet S from the right to the left is defined as the X-direction, and the direction that is orthogonal to the X-direction and that extends from the front (visible side) to the back (invisible side) of the drawing is defined as the Y-direction. Additionally, the directions opposite to the Z-direction, the X-direction, and the Y-direction are defined as the −Z-direction, the −X-direction, and the −Y-direction, respectively.

That is, in each drawing, an arrow X and an arrow Y represent horizontal directions that are mutually orthogonal to each other, and an arrow Z represents the up direction.

The recording apparatus 1 includes a paper feeding module 1000, a print module 2000, a drying module 3000, a fixing module 4000, a cooling module 5000, a reversing module 6000, and a discharged paper stacking module 7000. The sheet S in a form of cut sheet paper (cut paper) fed from the paper feeding module 1000 is conveyed along a conveyance path R indicated by a solid line in FIG. 1, subjected to processing in each module, and discharged to the discharged paper stacking module 7000. The paper feeding module 1000, the print module 2000, the drying module 3000, the fixing module 4000, the cooling module 5000, the reversing module 6000, and the discharged paper stacking module 7000 are each covered with a cover, which is not illustrated. Casters 10 are provided on the bottom portion to make independently movable the paper feeding module 1000, the print module 2000, the drying module 3000, the fixing module 4000, the cooling module 5000, the reversing module 6000, and the discharged paper stacking module 7000.

The paper feeding module 1000 includes three containers 1100a to 1100c that contain sheets S. The containers 1100a to 1100c are each pullable in the −Y-direction. Sheets S are fed one by one from each of the containers 1100a to 1100c by a separation belt and conveyance rollers, both of which are not illustrated, and are conveyed to the print module 2000. The number of containers is not limited to three, and the paper feeding module 1000 can include one, two, or four or more containers.

The print module 2000 includes a pre-image formation registration correction unit (not illustrated), a print belt unit 2200 as a conveyance belt, and a recording unit 2300. The sheet S conveyed from the paper feeding module 1000 is subjected to correction of the inclination and position of the sheet S by the pre-image formation registration correction unit, and conveyed to the print belt unit 2200. The recording unit 2300 is disposed at a position facing the print belt unit 2200 across the conveyance path R in the Z-direction. The recording unit 2300 is a sheet processing unit that performs recording processing (print) on the conveyed sheet S from above with a recording head (ejection head) 2301 to form an image. The sheet S is conveyed by the print belt unit 2200 while being sucked, and the conveyance mechanism ensures a clearance from the recording head 2301.

Liquid, such as ink, to be ejected from the recording head 2301 is supplied from a liquid supply apparatus 2400. Liquid to be supplied is assumed to come in various kinds of liquid, such as aqueous ink including latex ink, and solvent ink including eco-solvent ink. Each of these types of ink has an issue that moisture in ink evaporates over time, during which the ink is exposed to air, resulting in an increase in viscosity and solidification. Additionally, a reaction solution, which is ejected from the recording head 2301 similarly to ink and reacts with ink to fix the ink to the surface of the sheet S, is supplied from the liquid supply apparatus 2400.

A plurality of recording heads 2301 is arranged in the X-direction. In the present exemplary embodiment, a total of five linear recording heads 2301 corresponding to four colors of yellow (Y), magenta (M), cyan (C), and black (Bk), and the reaction solution. The number of colors of ink and the number of recording heads 2301 are not limited to five. As an ink-jet method, a method using a heating element, a method using a piezoelectric element, a method using an electrostatic element, a method using a micro-electro-mechanical system (MEMS) element, or other methods can be employed.

A maintenance unit 2600 is a unit including a mechanism of recovering ejection performance of the recording head 2301. Examples of such a mechanism can include a cap mechanism that protects the ink ejection surface of the recording head 2301, a wiper mechanism that wipes the ink ejection surface, and a suction mechanism that sucks ink in the recording head 2301 from the ink ejection surface with negative pressure. The maintenance unit 2600 also includes a driving mechanism and rails, which are not illustrated, and is reciprocally movable along the rails in the horizontal directions. The maintenance unit 2600 moves under the recording head 2301 when a maintenance operation is performed on the recording head 2301, and moves to an evacuation position from under the recording head 2301 when the maintenance operation is not performed.

The sheet S on which recording is performed by the recording unit 2300 is conveyed by the print belt unit 2200. Thereafter, an in-line scanner (not illustrated), which is disposed downstream of the recording unit 2300 in the conveyance direction, detects a shift and color density of an image formed on the sheet S and corrects the printed image.

The drying module 3000 includes a decoupling unit 3200, a drying belt unit 3300, and a warm air blowing unit 3400, and is a unit that reduces the amount of liquid contained in the ink applied to the sheet S by the recording unit 2300 to increase fixability between the sheet S and the ink. The sheet S on which printing is performed by the recording unit 2300 in the print module 2000 is conveyed to the decoupling unit 3200 disposed in the drying module 3000.

The decoupling unit 3200 has a function of blowing air toward the sheet S. The air blow presses the sheet S, which is pressed by a belt (not illustrated) as conveying means of the decoupling unit 3200, the pressing force of which generates frictional force between the sheet S and the belt, allowing the sheet S to be conveyed.

In this configuration, the sheet S on the belt is conveyed while being weakly held by the frictional force, preventing the sheet S on the print belt unit 2200 that forms an ink image from being shifted.

The sheet S conveyed from the decoupling unit 3200 is conveyed with suction in the drying belt unit 3300 with hot air being blown from the warm air blowing unit 3400 disposed above the belt, drying the surface of the sheet S to which the ink is applied. As a drying method, in addition to a hot-air drying method, a method of irradiating the surface of the sheet S with electromagnetic waves (e.g., ultraviolet rays or infrared rays) and a heat transfer method with a heating element in contact with the sheet S can be combined.

The fixing module 4000 includes a fixing belt unit 4100 including respective belts above and below the conveyance path R in the Z-direction. The fixing belt unit 4100 causes the sheet S conveyed from the drying module 3000 to pass between a heated upper belt unit 4110 and a heated lower belt unit 4120 to fix the ink to the sheet S. The cooling module 5000 includes a plurality of cooling units 5100 to cool the hot sheet S conveyed from the fixing module 4000. Each cooling unit 5100 takes the outside air into a cooling box with a fan to increase pressure inside the cooling box, and blows air out of nozzles in a conveyance guide to the sheet S to cool the sheet S. The cooling units 5100 are disposed above and below the conveyance path R in the Z-direction, allowing cooling both sides of the sheet S.

Additionally, the cooling module 5000 includes a conveyance path switching unit 5200, which is capable of switching the conveyance path of the sheet S depending on whether to convey the sheet S to the reversing module 6000 or to a double-sided printing conveyance path R2 used for double-sided printing. In the double-sided printing, the sheet S is conveyed to the double-sided printing conveyance path R2 below the cooling module 5000, and is further conveyed along the double-sided printing conveyance path R2 in the fixing module 4000, the drying module 3000, the print module 2000, and the paper feeding module 1000.

The sheet S is conveyed again to the pre-image formation registration correction unit (not illustrated) in the print module 2000, the print belt unit 2200, and the recording unit 2300, by which the sheet S is subjected to printing. A double-sided conveying unit in the fixing module 4000 is provided with a first reversing unit 4200 that reverses the front and back sides of the sheet S.

The reversing module 6000 includes a second reversing unit 6400, which is capable of reversing the front and back sides of the sheet S that is conveyed, and freely changing the orientation between the front and back sides of the sheet S to be discharged.

The stacking module 7000 includes a top tray 7200 and a stacking unit 7500, on which the sheets S conveyed from the reversing module 6000 are neatly stacked.

A control unit 8000 is a unit for controlling units of the recording apparatus 1. The control unit 8000 includes a central processing unit (CPU), a storage device, a controller including various kinds of control sections, an external interface, and an operation unit 8001 on which a user performs input/output. The operation unit 8001 has a function as a display unit that displays notifications to a user. The operation of the recording apparatus 1 is controlled based on commands from the controller or a host apparatus 8002, such as a host computer, that is connected to the controller via the external interface.

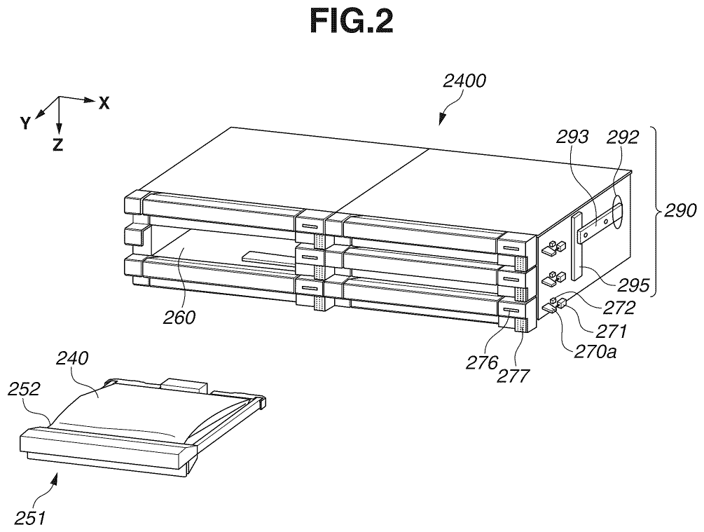

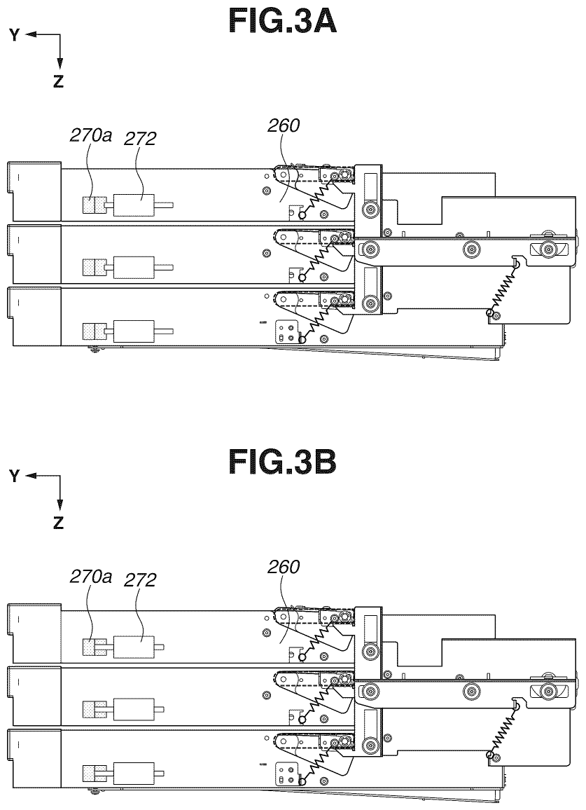

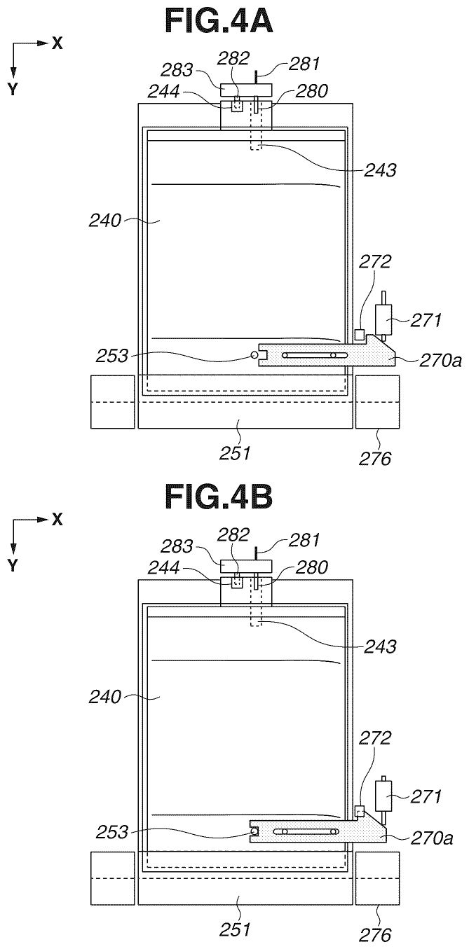

FIG. 2 is a perspective view illustrating the liquid supply apparatus 2400. FIG. 3A is a side view in a tray unlocked state, and FIG. 3B is a side view in a tray locked state. FIG. 4A is a top view in the tray unlocked state, and FIG. 4B is a top view in the tray locked state. A structure of the liquid supply apparatus 2400 will be described in more detail with reference to these drawings.

The liquid supply apparatus 2400 is normally enclosed with exterior parts, but FIG. 2 illustrates the liquid supply apparatus 2400 without the exterior parts so that its internal structure can be seen. Additionally, FIG. 2 illustrates a state where one of trays 251 is pulled out so that the relationship between the tray 251 and a tray holding unit 260 can be seen.

The liquid supply apparatus 2400 includes a plurality of tray holding units 260. An ink container 240, which contains liquid, such as ink, is set in each tray holding unit 260. The ink container 240 will be described below. A flow channel 281 formed as a flexible tube is connected to each tank, and is connected to a buffer tank in the recording apparatus 1 from the back of the liquid supply apparatus 2400. Each flow channel formed as a tube that extends from the buffer tank is connected to the corresponding flow channel in the recording apparatus 1, leading to the recording head 2301. In this manner, the flow channel from the ink container 240 to the buffer tank and the recording head 2301 is formed.

In the tray 251, the ink container 240 is detachably mounted on a mounting unit 252, and can be set in the tray holding unit 260. The tray 251 is provided with a protrusion 253 that protrudes upward from the lower surface. The tray 251 includes a lock member 270a that restricts operation of the tray 251 and a driving unit 271 to prevent a user from inadvertently pulling out the tray 251 that is set in the tray holding unit 260. The driving unit 271 includes, for example, a solenoid capable of maintaining a push/pull state.

When the driving unit 271 moves the lock member 270a in the −X-direction, the tray 251 is locked. When the driving unit 271 moves the lock member 270a in the +X-direction, the tray 251 is unlocked. More specifically, when the lock member 270a is moved in the −X-direction, the lock member 270a is engaged with the protrusion 253 in the tray 251, disallowing the user to pull the tray 251 out of the tray holding unit 260. In the tray unlock state, the lock member 270a is not engaged with the protrusion 253 in the tray 251, which does not restrict operation of the protrusion 253, allowing the user to pull the tray 251 out of the tray holding unit 260.

Supposing the user to pull out the tray 251 at any time, when the ink container 240 is pulled out of the tray 251, air flows from a supply needle 280 into the flow channel 281. This can cause ink in the flow channel 281 to solidify or the recording head 2301 to fail to eject the ink. Furthermore, when the ink container 240 is pulled out during printing on a recording medium or a maintenance operation by the maintenance unit 2600, the supply of ink is stopped, which can cause an abnormal stop of the recording apparatus 1.

To address this, in the present exemplary embodiment, the tray 251 is locked by the lock member 270a to disallow a user to pull the tray 251 out of the tray holding unit 260, and is unlocked in response to a command from the control unit 8000 for the exchange of the ink container 240.

A notification unit 276 and a label 277 are disposed on the right (+X-direction side) of the liquid supply apparatus 2400 when viewed from the front side. The notification unit 276 includes light emitting diodes (LEDs) in two colors, and is provided for each of the tray holding units 260. The LEDs in two colors are each switchable between turning the light on, blinking, and turning the light off. These patterns are combined to notify the user of a state of the ink container 240 in each of the tray holding units 260. Additionally, the label 277 allows the user to recognize that which of the tray holding units 260 should be set with the ink container 240 corresponding to the type of liquid.

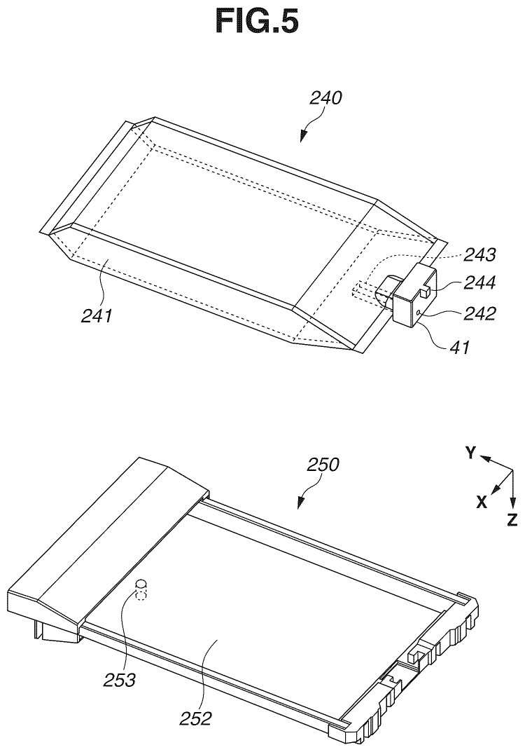

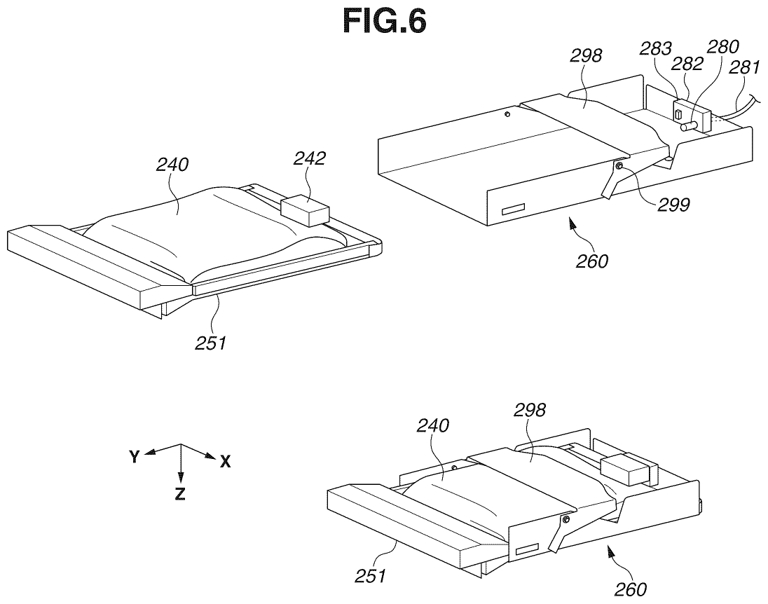

FIG. 5 is a perspective view illustrating the tray 251 and the ink container 240. Additionally, FIG. 6 is a perspective view illustrating the tray holding unit 260. The upper and lower surfaces of the ink container 240 are each formed of a flexible member. Additionally, a gusset section 241 that is folded inward to increase the amount of holding liquid is provided on each side of the ink container 240. The flexible members and the gusset sections 241 are welded together, forming a bag-shaped container. A large amount of liquid contained in the ink container 240 causes the gusset sections 241 to expand. A small amount of liquid in the ink container 240 causes the gusset sections 241 to be folded. Thus, the shape of the ink container 240 changes depending on the amount of liquid contained therein.

Normally, the ink container 240 is made of a plurality of layers including, for example, polyethylene terephthalate (PET). However, with an inner liquid that has a property of solidifying by reacting with air or the density and the remaining amount of which are changed by evaporation, the flexible members have a layer configuration including an aluminum layer to prevent the solidification of liquid and the change in density and remaining amount. Additionally, the ink container 240 is provided with a supply port 242, which is coupled to a water inlet 243 inside the ink container 240.

A spring biasing valve, which is not illustrated, is provided inside the supply port 242. The supply needle 280 provided in a supply needle holder 282 is inserted into the valve, opening the valve. The ink container 240 and the flow channel 281 downstream are coupled to each other, allowing the liquid to be supplied to the recording head 2301.

When the user mounts a new ink container 240 on the mounting unit 252 of the tray 251 and inserts the tray 251 into the tray holding unit 260, the tray 251 is set in the tray holding unit 260. When the tray 251 is set, a container substrate 244 including a contact provided in the vicinity of the supply port 242 and a connector 283 provided in the supply needle holder 282 come into contact with each other, establishing an electric connection.

The electric connection allows individual information, such as an amount of ink in the set ink container 240 and the type of contained liquid, to be read. This is used to determine whether the mounted ink container 240 is a new one or one that has been used once and is mounted again. Furthermore, it is determined whether the ink container 240 incompatible with the tray holding unit 260 is mounted, and whether the ink container 240 with an extremely small remaining amount of ink is mounted.

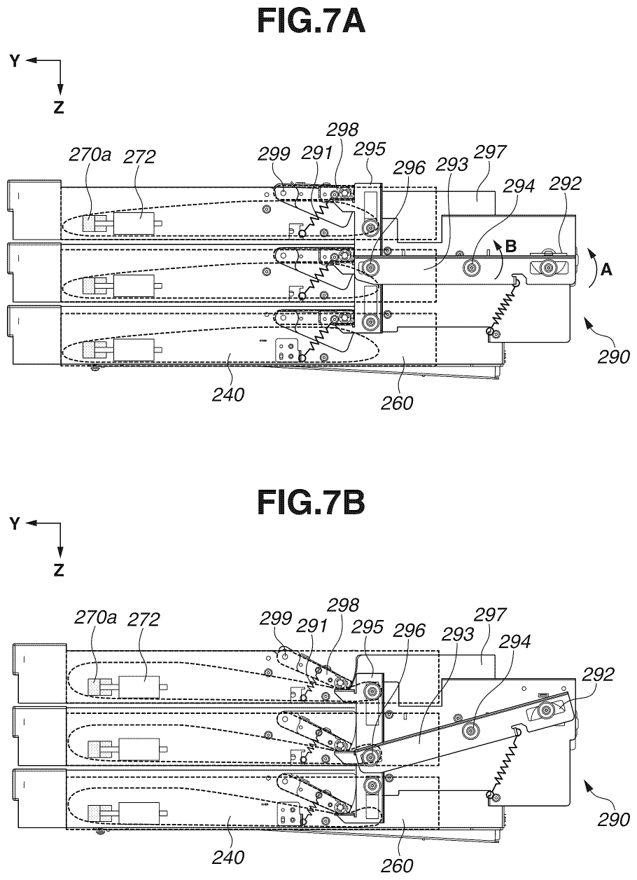

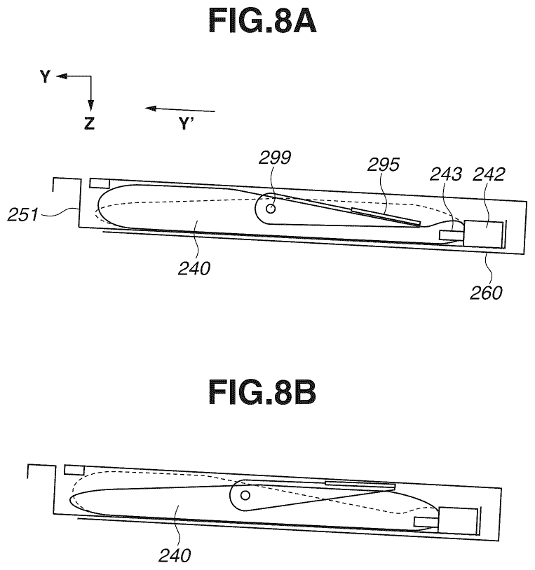

FIG. 7A is a side view illustrating a pressing release state where a pressing plate 298 does not press the ink container 240. FIG. 7B is a side view illustrating a pressing state where the pressing plate 298 presses the ink container 240. FIGS. 8A and 8B are schematical cross-sectional views each illustrating the ink container 240 and a pressing unit.

A stirring driving unit 290 for stirring the ink in the ink container 240 is provided on the side surface of the liquid supply apparatus 2400. A configuration of the stirring driving unit 290 will now be described.

A pressing unit elevating/lowering motor, which is not illustrated, transmits a driving force to a cam 292. A not-illustrated cam follower coupled to a driving force transmission lever 293 is disposed in the cam 292.

When the cam follower is elevated/lowered as the cam 292 is rotated in the direction of an arrow A, the driving force transmission lever 293 moves pivotally about a pivotal shaft 294 in the direction of an arrow B. The driving force transmission lever 293 is coupled to an elevating/lowering plate shaft unit 296 provided in an elevating/lowering plate 295 so that the operation of the driving force transmission lever 293 is converted into the elevating/lowering operation of the elevating/lowering plate 295. When the cam 292 rotates once, the cam follower moves reciprocally once in the up-and-down directions (Z-directions). As a result, the elevating/lowering plate 295 similarly performs an elevating/lowering operation to move reciprocally once via the driving force transmission lever 293. The elevating/lowering plate 295 is attached to a side plate 297 so as to elevate and lower in the Z-direction.

A mechanism of transmission of motive power from the elevating/lowering plate 295 to the pressing plate 298 will now be described. The pressing plate 298 provided in each of the tray holding units 260 receives the load applied by a spring 291 and presses the ink container 240. The pressing plate 298 is attached to the tray holding unit 260 so as to move pivotally about a pivotal shaft 299 as its pivotal axis. Each spring 291 applies load to the pressing plate 298 in the clockwise direction in each of FIGS. 7A and 7B.

As illustrated in FIG. 7A, with the pressing plate 298 in the pressing release state, the elevating/lowering plate 295 is brought into contact with the pressing plate 298 and lifts the pressing plate 298. As illustrated in FIG. 7B, with the pressing plate 298 in the pressing state, the cam 292 is in a phase that is 180-degrees opposite to a phase in the pressing release state, and the pressing plate 298 is in contact with the ink container 240 in the pressing state.

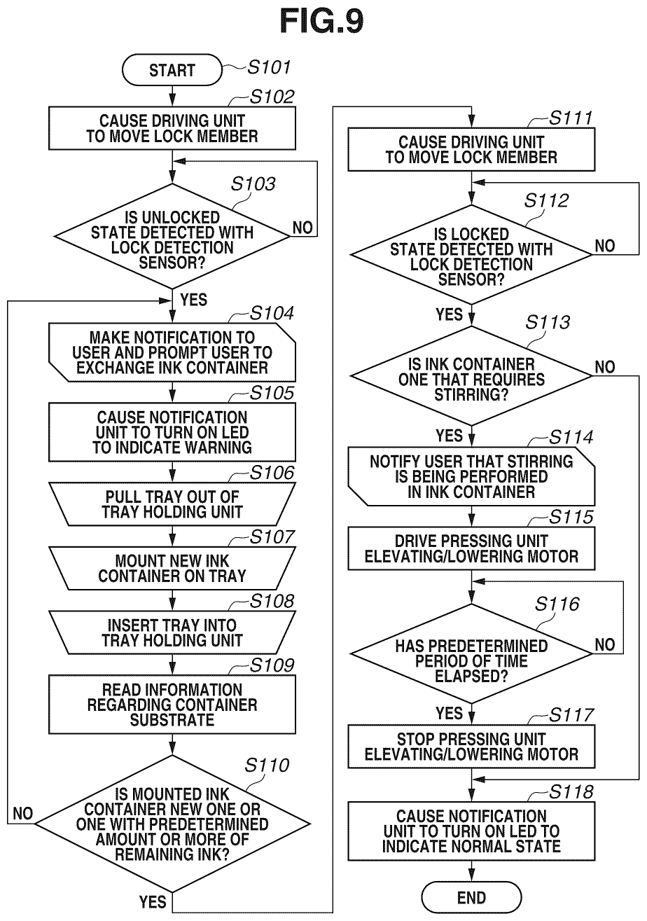

A control procedure for exchanging the ink container 240 will now be described with reference to FIG. 9. FIG. 9 is a control flowchart for exchanging the ink container 240, and the control is performed by the control unit 8000.

In step S101, with the amount of remaining ink in the ink container 240 less than a predetermined amount, the procedure is started.

In step S102, the control unit 8000 sends a command for unlocking to the driving unit 271, the driving unit 271 is caused to move the lock member. In step S103, the control unit 8000 detects whether the lock member 270a is in the tray unlocked state with a lock detection sensor 272.

When the tray unlocked state is detected (YES in step S103), the processing proceeds to step S104. In step S104, the control unit 8000 displays, on the operation unit 8001, a guide screen prompting the user to exchange the ink container 240 for a new one.

In step S105, a control signal is transmitted from the host apparatus 8002 to the notification unit 276 to cause the LED to turn on to indicate a warning. The notification to the user is not limited to displaying on the operation unit 8001, and can be performed using a sound or vibrations. Furthermore, the notification can be performed via the host apparatus 8002.

In step S106, the user pulls the tray 251 out of the tray holding unit 260. In step S107, the user mounts a new ink container 240 on the mounting unit 252 in the tray 251. In step S108, the user inserts the tray 251 into the tray holding unit 260 to bring the tray 251 into the set state. As described above, steps S106 to S108 are executed by manual operations performed by the user.

In step S109, with the tray 251 in the set state, when the container substrate 244 and the connector 283 provided in the supply needle holder 282 come into contact with each other, establishing an electrical connection to each other, the control unit 8000 reads information regarding the container substrate 244. In step S110, the control unit 8000 determines, based on the information regarding the container substrate 244, whether the mounted ink container 240 is a new one or one with the predetermined or more amount of remaining ink that is mounted thereon again. If it is determined that the mounted ink container 240 is a new one or one with the predetermined or more amount of remaining ink (YES in step S110), the processing proceeds to step S111. In step S111, the control unit 8000 drives the driving unit 271 to move the lock member 270a in the −X-direction to bring the lock member 270a into the tray locked state.

In step S112, the control unit 8000 then uses the lock detection sensor 272 to detect the tray locked state of the lock member 270a where the lock member 270a restricts operation of the tray 251. If the amount of remaining ink in the mounted ink container 240 is smaller than the predetermined amount (NO in step S110), the processing returns to step S104, in which the guide screen remains in the state of prompting the user to exchange the ink container 240 for a new one.

Thereafter, in step S113, because it is necessary to eliminate the sedimentation of components depending on the type of liquid, the control unit 8000 determines whether the ink container 240 is one that contains liquid that requires stirring. If the ink container 240 is one that requires no stirring (NO in step S113), the processing proceeds to step S118. In step S118, the control unit 8000 causes the notification unit 276 to turn on the LED to indicate a “normal state”. On the other hand, if the ink container 240 is one that requires stirring (YES in step S113), the processing proceeds to step S114. In step S114, the control unit 8000 changes the guide screen for the user to a display screen indicating that stirring is being performed in the ink container 240.

In step S115, the control unit 8000 continues to drive the pressing unit elevating/lowering motor until a predetermined period of time elapses. In step S116, the control unit 8000 determines whether the predetermined period of time has elapsed. If the predetermined period of time has elapsed (YES in step S116), the processing proceeds to step S117. In step S117, the control unit 8000 stops the pressing unit elevating/lowering motor. While the method of managing a stirring operation with the elapse of time has been described, the stirring operation can be managed with a pulse count utilizing a pulse motor or an encoder sensor, or with the number of pressings based on the number of detections with the rotation detection sensor. In step S118, after the completion of stirring, the control unit 8000 hides the warning display prompting the user to exchange the ink container 240 for a new one, and causes the notification unit 276 to turn on the LED to indicate the “normal state”.

The control procedure for exchanging the ink container 240 according to the present exemplary embodiment has been described above. In this manner, when the procedure for exchange is completed, the tray locked state where the tray 251 is locked by the lock member 270a is maintained. Thus, the user is unable to pull out the tray 251 (ink container 240) at a desired time unless the control unit 8000 sends a command for unlocking the tray 251 with the amount of ink in the ink container 240 less than the predetermined amount. This configuration can prevent the condensation of ink in the flow channel 281 and ejection malfunction with the recording head 2301 due to the exposure of the supply port 242 and the supply needle 280 in the ink container 240 to air, causing the evaporation of the moisture of the inner liquid.

A second exemplary embodiment of the present disclosure will be described. The description of a part of configuration similar to that in the first exemplary embodiment is omitted.

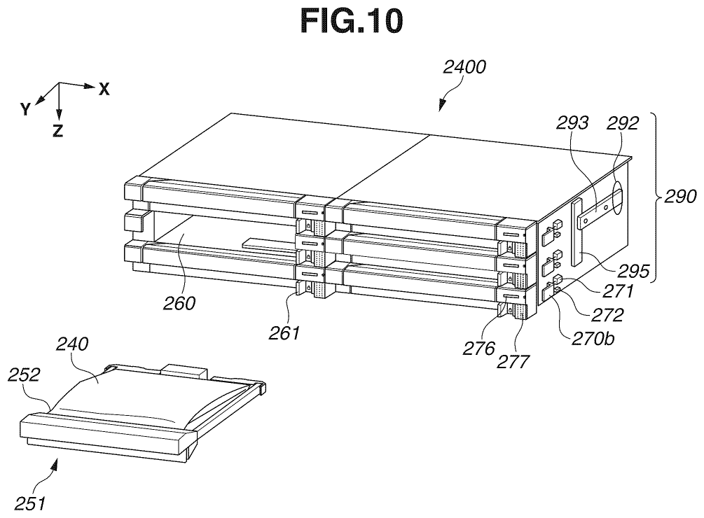

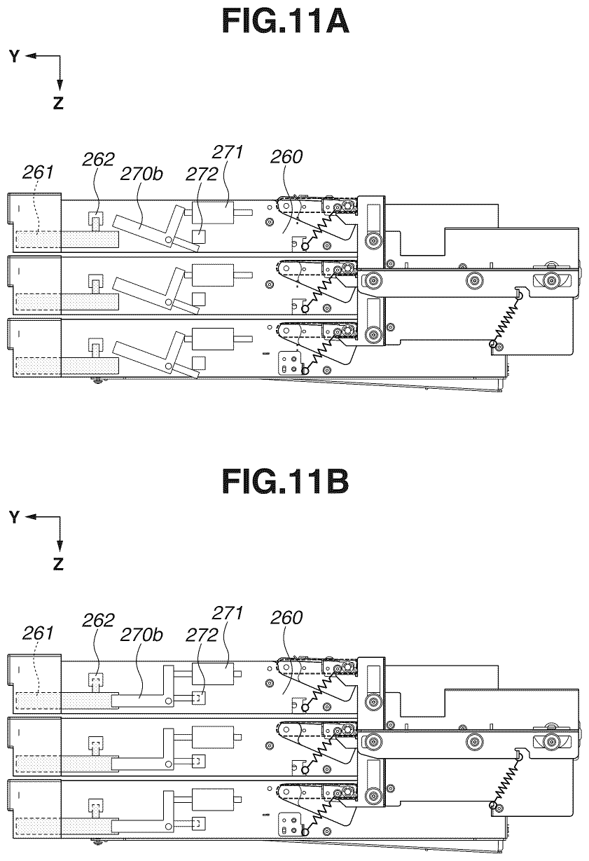

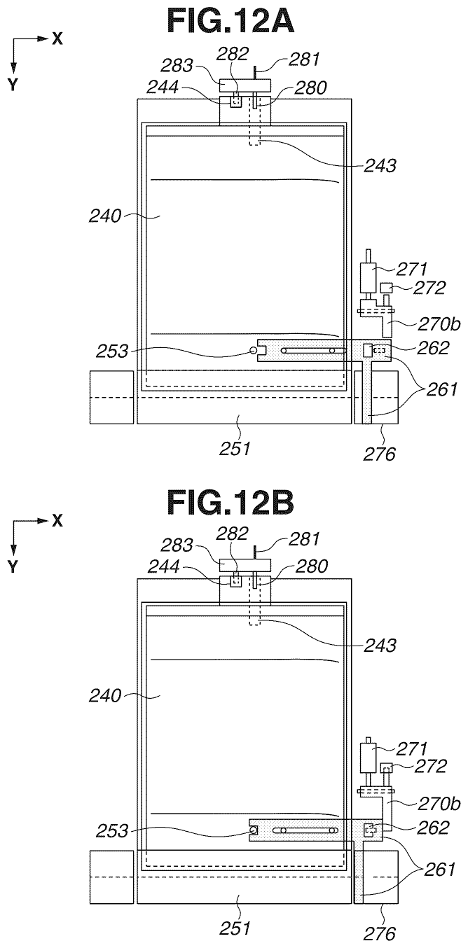

FIG. 10 is a perspective view illustrating a liquid supply apparatus 2400 according to the present exemplary embodiment. FIG. 11A is a side view in a lever unlocked state, and FIG. 11B is a side view in a lever locked state. FIG. 12A is a top view in the lever unlocked state, and FIG. 12B is a top view in the lever locked state.

In the first exemplary embodiment, each tray 251 is locked by the lock member 270a. In contrast, in the present exemplary embodiment, each tray 251 is locked by an operation lever 261 via a lock member 270b. The components the same as those in the first exemplary embodiment are denoted by the same reference numbers.

Each tray 251 is provided with the operation lever 261 to prevent a user from inadvertently pulling out the tray 251 that is set in the tray holding unit 260. The operation lever 261 is provided movable in the X-direction by a user operation. With the operation lever 261 moved in the −X-direction, the operation lever 261 is in the lever locked state (restriction position). With the operation lever 261 moved in the +X-direction, the operation lever 261 is in the lever unlocked state (non-restriction position).

In the lever locked state where the operation lever 261 is moved in the −X-direction, the operation lever 261 is engaged with the protrusion 253 in the tray 251 so that the movement of the tray 251 is restricted. Additionally, in the lever unlocked state, since the operation lever 261 does not restrict the operation of the protrusion 253 in the tray 251, the user can pull out the tray 251.

A lever detection sensor 262 is provided on the right (+X side) of the tray holding unit 260 when viewed from the front side, and can detect the lever locked state and the lever unlocked state depending on the positional relationship with a sensor flag coupled to the operation lever 261. In other words, the lever detection sensor 262 can detect the restriction position or the non-restriction position of the operation lever 261.

The lock member 270b that restricts the operation of the operation lever 261 and a driving unit 271 are provided to prevent the user from inadvertently pulling out the tray 251 in the lever locked state. The driving unit 271 includes, for example, a solenoid capable of maintaining a push/pull state. When the driving unit 271 moves the lock member 270b in the +Y-direction, the lock member 270b is brought into the lever locked state. When the driving unit 271 moves the lock member 270b in the −Y-direction, the lock member 270b is brought into the lever unlocked state. The lock detection sensor 272 is provided near the driving unit 271. The lock detection sensor 272 can detect the lever locked state of the lock member 270b, which restricts the operation of the operation lever 261, or the lever unlocked state based on the positional relationship with the sensor flag coupled to the lock member 270b.

Supposing the user moves the operation lever 261 in the +X-direction at a desired time to make a transition to the lever unlocked state, air can flow from the supply needle 280 into the flow channel 281 when the ink container 240 is pulled out. This can cause solidification of the ink in the flow channel 281 and ejection malfunction of the recording head 2301. Furthermore, when the ink container 240 is pulled out during printing on a recording medium or a maintenance operation by the maintenance unit 2600, the supply of ink is stopped, which can cause an abnormal stop of the recording apparatus 1.

To address this, in the present exemplary embodiment, the tray 251 is locked by the operation lever 261, and the lock is released by a command from the control unit 8000 as appropriate.

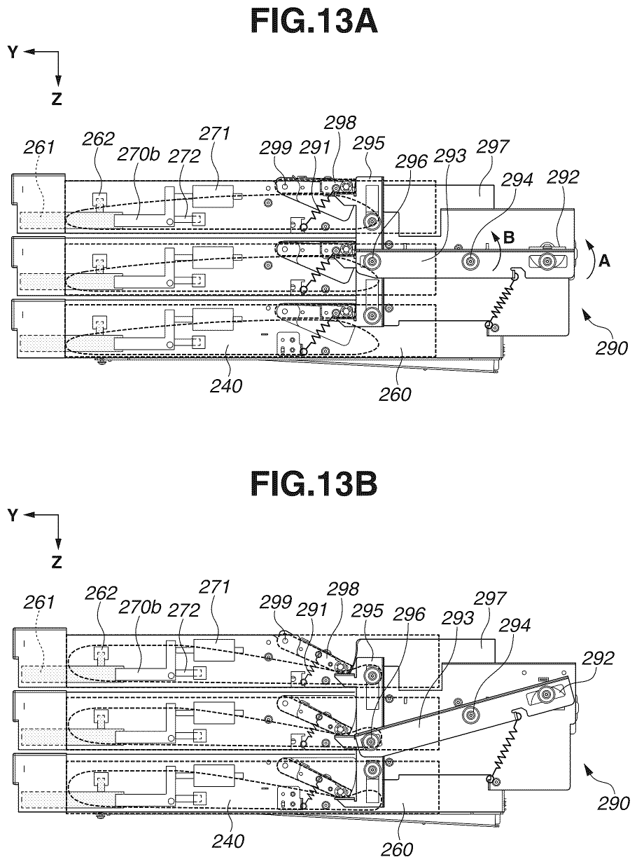

FIG. 13A is a side view illustrating a pressing release state where the pressing plate 298 does not press the ink container 240. FIG. 13B is a side view illustrating a pressing state where the pressing plate 298 presses the ink container 240. Similarly to the first exemplary embodiment, with the pressing plate 298 in the pressing release state as illustrated in FIG. 13A, the elevating/lowering plate 295 is in contact with the pressing plate 298 and lifts the pressing plate 298.

In contrast, with the pressing plate 298 in the pressing state as illustrated in FIG. 13B, the cam 292 is in a phase that is 180-degrees opposite to a phase in the pressing release state, and the pressing plate 298 is in contact with the ink container 240 in the pressing state.

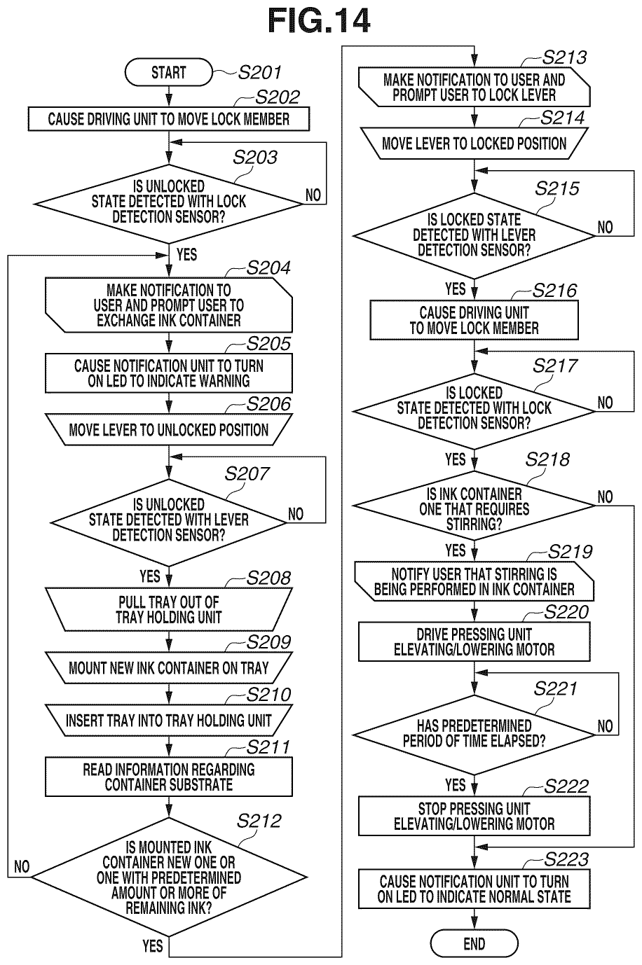

A control procedure for exchanging the ink container 240 will now be described with reference to FIG. 14. FIG. 14 is a control flowchart for exchanging the ink container 240 according to the present exemplary embodiment, and the control is performed by the control unit 8000.

In step S201, with the amount of remaining ink in the ink container 240 less than a predetermined amount, the procedure is started.

In step S202, the control unit 8000 sends a command for unlocking to the driving unit 271. In step S203, the control unit 8000 detects whether the lock member 270b is in the lever unlocked state with the lock detection sensor 272.

In step S204, with the lever unlocked state detected, the control unit 8000 displays, on the operation unit 8001, the guide screen prompting the user to exchange the ink container 240 for a new one. In step S205, a control signal is transmitted from the host apparatus 8002 to the notification unit 276 to cause the LED to turn on to indicate a warning. The notification to the user is not limited to displaying on the operation unit 8001, and can be performed using a sound or vibrations. Furthermore, the notification can be performed via the host apparatus 8002.

In step S206, the user moves the operation lever 261 in the +X-direction to bring the operation lever 261 into the lever unlocked state. In step S207, the control unit 8000 then detects the unlocked state of the operation lever 261 with the lever detection sensor 262.

Subsequently, in step S208, the user pulls the tray 251 out of the tray holding unit 260. In step S209, the user mounts the new ink container 240 on the mounting unit 252 in the tray 251. In step S210, the user inserts the tray 251 into the tray holding unit 260 to bring the tray 251 into the set state. As described above, steps S206, and S208 to S210 are executed by manual operations performed by the user.

In step S211, with the tray 251 in the set state, when the container substrate 244 and the connector 283 provided in the supply needle holder 282 come in contact with each other, establishing an electrically connection to each other, the control unit 8000 reads information regarding the container substrate 244. In step S212, the control unit 8000 determines, based on the information regarding the container substrate 244, whether the mounted ink container 240 is a new one or one with the predetermined or more amount of remaining ink that is mounted again.

When it is determined that the mounted ink container 240 is a new one or one with the predetermined or more amount of remaining ink (YES in step S212), the processing proceeds to step S213. In step S213, the control unit 8000 displays, on the operation unit 8001, the guide screen prompting the user to bring the operation lever 261 into the locked state. If the amount of remaining ink in the mounted ink container 240 is smaller than the predetermined mount (NO in step S212), the processing returns to step S204, in which the guide screen remains in the state of prompting the user to exchange the ink container 240 for a new one. The notification to the user is not limited to displaying on the operation unit 8001, and can be performed using a sound or vibrations. Furthermore, the notification can be performed via the host apparatus 8002.

In step S214, the user manually moves the operation lever 261 in the −X-direction to make a transition to the lever locked state. This operation causes the operation lever 261 to engage with the protrusion 253 in the tray 251, which prevents the user from pulling out the tray 251 even if the user operates a tray handle 254. In step S215, the control unit 8000 then detects the locked state of the operation lever 261 with the lever detection sensor 262. Even if the control unit 8000 detects the locked state of the operation lever 261 with the ink container 240 not mounted, the guide screen remains in the state of prompting the user to exchange the ink container 240 for a new one.

In step S216, when the operation lever 261 is in the locked state with the ink container 240 mounted, the control unit 8000 causes the driving unit 271 to move the lock member 270b in the +Y-direction to bring the lock member 270b into the lever locked state.

In step S217, the control unit 8000 then detects the lever locked state where the lock member 270b restricts the operation of the operation lever 261 with the lock detection sensor 272.

Thereafter, in step S218, because it is necessary to eliminate the sedimentation of components depending on the type of liquid, the control unit 8000 determines whether the ink container 240 is one that contains liquid that requires stirring. If the ink container 240 is one that requires no stirring (NO in step S218), the processing proceeds to step S223. In step S223, the control unit 8000 causes the notification unit 276 to turn on the LED to indicate the “normal state”. On the other hand, if the ink container 240 is one that requires stirring (YES in step S218), the processing proceeds to step S219. In step S219, the control unit 8000 changes the guide screen for the user to a display screen indicating that stirring is being performed in the ink container 240.

In step S220, the control unit 8000 continues to drive the pressing unit elevating/lowering motor until a predetermined period of time elapses. In step S221, the control unit 8000 determines whether the predetermined period of time has elapsed. If the predetermined period of time has elapsed (YES in step S221), the processing proceeds to step S222. In step S222, the control unit 8000 stops the pressing unit elevating/lowering motor. While the method of managing the stirring operation with the elapse of time has been described, the stirring operation can be managed with a pulse count utilizing a pulse motor or an encoder sensor, or with the number of pressings based on the number of detections with the rotation detection sensor. In step S223, after the completion of stirring, the control unit 8000 hides the warning display prompting the user to exchange the ink container 240 for a new one, and causes the notification unit 276 to turn on the LED to indicate the “normal state”.

The control procedure for exchanging the ink container 240 according to the second exemplary embodiment has been described above. Thereafter, when the procedure for exchange is completed in this manner, the lever locked state where the tray 251 is locked by the lock member 270b is maintained. Thus, the user is unable to pull out the tray 251 (ink container 240) at a desired time unless the control unit 8000 sends a command for unlocking the operation lever 261 with the amount of ink in the ink container 240 less than the predetermined amount. This prevents the condensation of ink in the flow channel 281 and the ejection malfunction in the recording head 2301 due to the exposure of the supply port 242 and the supply needle 280 in the ink container 240 to air, causing the evaporation of the moisture of the inner liquid.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-121142, filed Jul. 25, 2023, which is hereby incorporated by reference herein in its entirety.

What is claimed is:

1. A liquid ejection apparatus comprising:
a holding unit configured to hold a tray on which a container configured to contain liquid to be supplied to an ejection head is detachably mounted;
a first restriction unit configured to be movable to a restriction position where the first restriction unit restricts pulling the tray out of the holding unit and to a non-restriction position where the first restriction unit does not restrict pulling the tray out of the holding unit;
a connector configured to be in contact with a substrate of the container; and
a second restriction unit configured to, in a case where the substrate is in contact with the connector and the first restriction unit is at the restriction position, restrict movement of the first restriction unit to the non-restriction position.

2. The liquid ejection apparatus according to claim 1, wherein, in a case where the substrate and the connector are out of contact with each other, the second restriction unit is configured not to restrict the movement of the first restriction unit to the non-restriction position.

3. The liquid ejection apparatus according to claim 1, further comprising a detection unit configured to detect whether the first restriction unit is at the restriction position or the non-restriction position.

4. The liquid ejection apparatus according to claim 1, wherein the second restriction unit is configured to be driven by a solenoid.

5. The liquid ejection apparatus according to claim 1, wherein the first restriction unit is configured to be operated by a user.

6. The liquid ejection apparatus according to claim 5, wherein, in a case where the substrate and the connector are in contact with each other with the first restriction unit at the non-restriction position, a notification prompting a user to move the first restriction unit to the restriction position is made.

7. The liquid ejection apparatus according to claim 1, further comprising a display unit configured to display a notification to a user.

8. The liquid ejection apparatus according to claim 1, further comprising a stirring unit configured to perform stirring in the container with the movement of the first restriction unit restricted by the second restriction unit.

9. The liquid ejection apparatus according to claim 1, wherein, in a case where an amount of the liquid contained in the container is less than a predetermined amount, the second restriction unit is configured to lift restriction of the movement of the first restriction unit.

10. A liquid ejection apparatus comprising:
a holding unit configured to hold a tray on which a container configured to contain liquid to be supplied to an ejection head is detachably mounted;
a connector configured to be in contact with a substrate of the container; and
a restriction unit configured to, in a case where the substrate and the connector are in contact with each other, restrict pulling the tray out of the holding unit.

11. The liquid ejection apparatus according to claim 10, further comprising a detection unit configured to detect whether the restriction unit is at a restriction position where the restriction unit restricts pulling the tray out of the holding unit or at a non-restriction position where the restriction unit does not restrict pulling the tray out of the holding unit.

12. The liquid ejection apparatus according to claim 10, wherein the restriction unit is configured to be driven by a solenoid.
